(19) United States
(12) Patent Application Publication
(10) Pub. No.: US 2023/0276737 A1
(43) Pub. Date: Sep. 7, 2023

(54) THRESHING CONCAVE WITH THRESHING PLATES FOR AN AGRICULTURAL COMBINE

(71) Applicant: C&C Combine Performance, LLC, Brazoria, TX (US)

(72) Inventor: Chad A. Koudela, Brazoria, TX (US)

(73) Assignee: C&C Combine Performance, LLC, Brazoria, TX (US)

(21) Appl. No.: 18/176,710

(22) Filed: Mar. 1, 2023

Related U.S. Application Data
(60) Provisional application No. 63/317,344, filed on Mar. 7, 2022.

(51) Int. Cl. A01F 12/24

(52) U.S. Cl. CPC A01F 12/24

(57) ABSTRACT

A threshing concave for an agricultural combine for harvesting different types of crops is disclosed. The concave has a curved frame comprising two curved end members extending between two side members, a plurality of threshing bars, each threshing bar extending between the two curved end members, and a plurality of threshing plates, each threshing plate extending between the two curved end members.

### REFERENCE TO RELATED APPLICATIONS

This application claims priority to provisional application U.S. Provisional Application Ser. No. 63/317,344, filed Mar. 7, 2022, and entitled “THRESHING CONCAVE WITH THRESHING PLATES FOR AN AGRICULTURAL COMBINE,” which is specifically and entirely incorporated by reference.

### BACKGROUND OF THE INVENTION

### A. Technical Field

The present invention generally relates to a threshing concave for an agricultural combine. More particularly, the invention disclosed herein relates to a universal threshing concave design with threshing plates, which could be used for harvesting different types of crops. Further, using this threshing concave design with threshing plates, the agriculture combine system could be able to release more grains, reduce the amount of damage and accelerate the cleaning process.

### B. Description of Related Art

A modern combine harvester, or simply combine, is a versatile machine designed to efficiently harvest a variety of grain crops. The name derives from its combining three separate harvesting operations such as, reaping, threshing, and windrowing into a single process. Among the crops harvested with a combine are wheat, oats, rye, barley, maize or corn, sorghum, soybeans, flax, sunflowers and canola. The separated straw, left lying on the field, comprises the stems and any remaining leaves of the crop with limited nutrients left in it. The straw is then either chopped, spread on the field and ploughed back in, or baled for bedding and limited-feed for livestock. Combine harvesters are one of the most economically important labor-saving machines, significantly reducing the fraction of the population engaged in agriculture.

Despite great advances in mechanics and computer control, the basic operation of the combine harvester has remained unchanged almost since it was invented. FIGS. 1 depicts an example of an existing combine harvester 1. Rotary combines have a rotary crop processing unit 2 that threshes and separates the grain from the harvested crop material. The rotary crop processing unit is formed by a rotor radially surrounded by a casing. The rotor and casing together define an inlet section, a threshing section and a separating section. In many combine harvester designs, the bottom of the casing has a concave under the threshing section for threshing the crop material and a separating grate under the separator section for separating the grain from the threshed crop material. The inlet 3 section pulls the harvested crop material from a front crop gathering unit into the threshing section 4. The threshing section 4 threshes the crop material and then feeds the threshed crop material to the separator section.

Within the threshing section 4, there is typically a threshing rotor 5 that tumbles the cut crops to break and shake the grains away from their stalks. One or more concaves 6 are typically positioned below and work in conjunction with the threshing rotor 5. FIGS. 1 shows three concaves. Generally, each concave 6 is provided with a combination of threshing elements in the form of straight bars square in cross-section that are spaced apart from one another with wires between the bars. The objective of the bars and wires is to restrict the flow of crop material so as to enhance threshing of the crop material in the threshing section. However, for harvesting corn crops, a tendency frequently develops for crop material flow to be restricted too much by corn shucks getting hung up on the bars and catching on the wires, resulting in clogging of the concave. One solution of the prior art is to change the threshing elements of the concave to round bars with no wires. In some previous inventions, the concave with an array of longitudinal notched and spaced apart threshing elements is disclosed. However, a tendency frequently develops under some crop conditions, other than corn, for too little restriction of crop material flow such that the other crop materials are not threshed effectively, resulting in overloading of the separator section.

From the concave, the crop enters a collection tank 7 via augers 8. The chaff (unwanted material) passes thru the rotor to the discharge beater or chopper toward the rear of machine 1. When the collection tank 7 is full, a collection vehicle pulls alongside the combine. The grain is carried up from the tank by an elevator and shoots out of a side pipe 9 (sometimes called the unloader) into the collection vehicle. The unwanted chaff tumbles from the back of the machine 1. Some combines have a rotating spreader mechanism that throws the straw over a wide area. Often the straw is baled up by a baling machine and used for animal bedding.

FIG. 1B depicts a typical concave 6. The concave 6 includes a frame 10 and an array of elongated threshing elements or bars 12 supported by the frame 10. The frame 10 is formed by opposite end members (17 and 18), one or more intermediate members 16 and opposite side members (14 and 15). The end members (17 and 18) and intermediate member 16, are in the form of relatively thin elongated plates. The intermediate member 16 is spaced substantially equidistantly between the end members (17 and 18) and extends generally parallel thereto.

In the light of above-mentioned issues, there exists a need for a universal threshing concave design for an agricultural combine, which could be used for harvesting different types of crops. Further, there is a need for a threshing concave that could be able to release more grains, reduces grain damage and accelerates the following cleaning process.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor it is intended for determining the scope of the claimed subject matter.

One embodiment of the invention is directed to a threshing concave for an agricultural combine. The concave has a curved frame comprising two curved end members extending between two side members, a plurality of threshing bars, each threshing bar extending between the two curved end members, and a plurality of threshing plates, each threshing plate extending between the two curved end members.

In a preferred embodiment, each threshing plate has a flat surface with fingers extending therefrom. Preferably, there are at least two lengths of fingers. The flat surface is preferably positioned to come into contact with a crop when in use and the fingers extend in a direction of crop flow when in use. The concave preferably further comprises an intermediary member positioned between the end members and the threshing bars and threshing plates extend between one end member and the intermediary member.

Preferably, the threshing bars and threshing plates extend to a same height within the concave. In a preferred embodiment there is at least one array of threshing bars adjacent to each other and at least one array of threshing plates adjacent to each other. Preferably, the concave is adapted to thresh multiple crops without adaptation. The threshing plates are preferably removable and replaceable without disassembling the concave. The concave preferably further comprises a plurality of threshing plate brackets adapted to provide a coupling point between the concave and the threshing plates.

Another embodiment is directed to an agricultural combine. The combine comprises a rotor and at least one threshing concave. The threshing concave comprises a curved frame comprising two curved end members extending between two side members, a plurality of threshing bars, each threshing bar extending between the two curved end members, and a plurality of threshing plates, each threshing plate extending between the two curved end members.

Preferably, each threshing plate has a flat surface with fingers extending therefrom. In a preferred embodiment, there are at least two lengths of fingers. Preferably, the flat surface is positioned to come into contact with a crop when in use and the fingers extend in a direction of crop flow when in use. The concave preferably further comprises an intermediary member positioned between the end members and the threshing bars and threshing plates extend between one end member and the intermediary member. Preferably, the threshing bars and threshing plates extend to a same height within the concave.

In a preferred embodiment, there is at least one array of threshing bars adjacent to each other and at least one array of threshing plates adjacent to each other. Preferably, the concave is adapted to thresh multiple crops without adaptation. The threshing plates are preferably removable and replaceable without disassembling the concave. The concave preferably further comprises a plurality of threshing plate brackets adapted to provide a coupling point between the concave and the threshing plates.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1A depicts a general configuration of a combine harvester.

FIG. 1B depicts a typical threshing concave.

FIG. 2 depicts a side view of an embodiment a portion of the frame of a threshing concave.

FIG. 3 depicts a view of an embodiment of threshing plates.

FIG. 4 depicts a view of an embodiment an assembled threshing concave.

FIG. 5 depicts a back view of the embodiment of the assembled threshing concave shown in FIG. 4.

FIG. 6 depicts embodiments of threshing plate brackets.

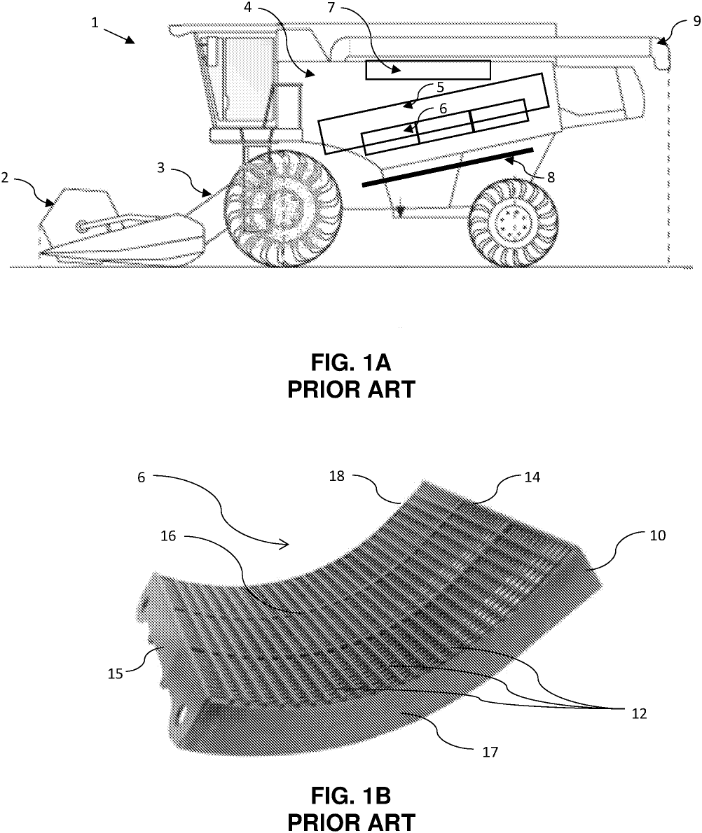

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention discloses a threshing concave design for an agricultural combine that could be applicable for harvesting different types of crops. The threshing concave may be original to the combine or may be add to the combine later as an aftermarket device. The threshing concave according to the present invention further helps in accelerating the threshing process of grains by accelerating the separation process. Further, using the threshing concave described herein, the agriculture combine system could be able to release more than 80%, 85%, 90%, or more of the grains sooner, therefore allowing greater yield. A faster release of grains from the threshing section reduces the amount of damage and accelerates the cleaning process.

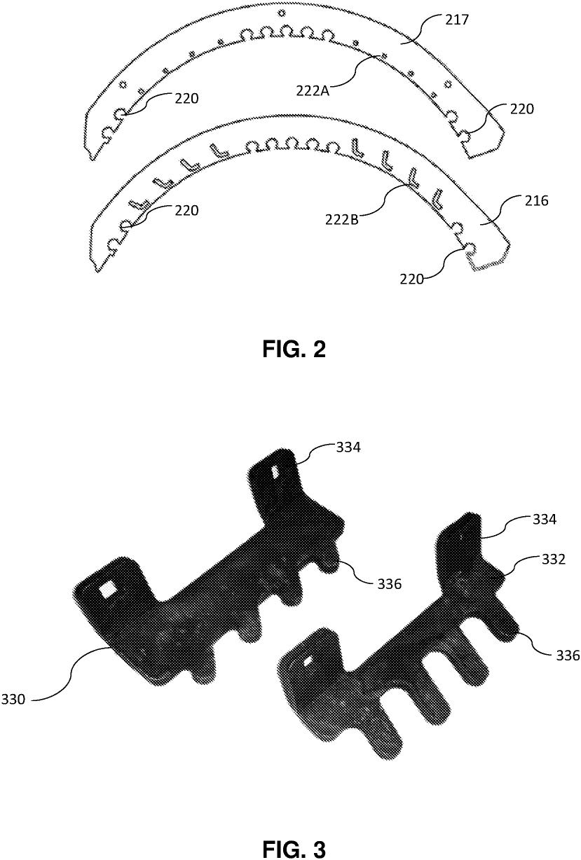

FIG. 2 shows an embodiment of an end member 217 and an intermediary member 216. Preferably each concave has two end members 217 and at least one intermediary member 216. FIG. 3 shows two embodiments of threshing plates 330 and 332. Preferably, each concave has at least one threshing plate 330 and at least one threshing plate 332. Each threshing plate 330 and 332 preferably has ears 334 bent perpendicularly to fingers 336. However, ears 334 can be at an acute or an obtuse angle to fingers 336. Preferably, each threshing plate 330 and 332 has two ears 334, but there may be more or fewer ears. Preferably, threshing plate 330 has shorter fingers 336 than threshing plate 332.

Preferably, threshing plates 330 and 332 have open ended fingers 336 to allow for self-cleaning and to prevent plugging or clogging. The different lengths of fingers 336 are adapted to control and adjust cleaning of the shoe load for different crops and conditions. Preferably, the fingers allow for the machine to load more evenly than without the fingers for better performance and cleaning.

Returning to FIG. 2, each end member 217 and intermediary member 216 preferably has a plurality of sets of recesses 220, each adapted to accept a threshing bar. The sets of recesses can be in pairs, threes, fours, fives, or more. In other embodiments there are only individual recesses. Preferably, there are two, three, four, five, or more sets. Between the sets recesses 220 are preferably positioned connection points 222A and 222B for threshing plates 330 and 332. Preferably, there is one connection point 222A on end member 217 and a corresponding connection point 222B on intermediary member 216. Preferably the connection points 222A and 222B are arranged in sets. There may be 1 set, 2, sets, 3 sets, or more sets. Preferably each set has 1 connection point 222A and 222B, 2 connection points 222A and 222B, 3 connection points 222A and 222B, 4 connection points 222A and 222B, or more connection points 222A and 222B. Each set can accept only threshing plate 330, only threshing plate 332, or a combination of threshing plates 330 and 332.

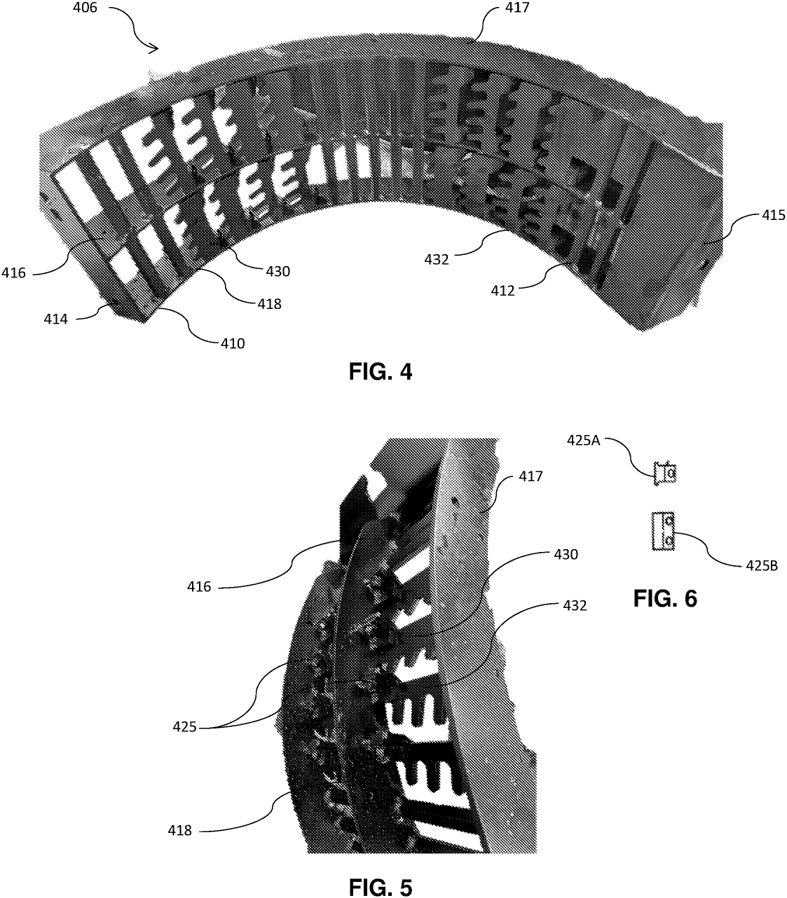

For example, FIG. 4 depicts an embodiment of one possible configuration of a concave 406. Concave 406 preferably has frame 410 comprised of end members 417 and 418, intermediary member 416, and side members 414 and 415. Preferably, between end member 417 and intermediary member 416 and end member 418 and intermediary member 416 are bars 412 and threshing plates 430 and 432. As can be seen in the figure, threshing plates 430 and 432 are arranged in pairs and next to each pair of threshing plates 430, both horizontally and vertically, is a pair of threshing plates 432, and vice versa. In other arrangements, all threshing plates 430 can be placed together and all threshing plates 432 can be placed together, the threshing plates may be alternated, placed randomly, placed in rows of the same threshing plates, columns of the same threshing plates, or otherwise arranged.

Preferably, threshing plates 430 and 432 are removable and replaceable without disassembling frame 410. For example, as can be seen in FIG. 5, showing a back side view of concave 406, threshing plates 430 and 432 may be coupled to end members 417 and 418 and intermediary member 416 by brackets 425. Brackets 425 are preferably “L” shaped and are fixed to either end member 417, end member 418, or intermediary member 416 (i.e. by welding). The brackets attached to the end members may be the same or different than the brackets attached to the intermediary member. For example FIG. 6 shows two different sized brackets 425A and 425B. Brackets 425 preferably are adapted to accept a bolt, or other coupling device, so that threshing plates 430 and 432 can be removably mounted to brackets 425. In other embodiments, brackets 425 may have a threaded rod attached thereto, a locking mechanism, a clamping mechanism, or another fixation device to hold the threshing plates.

As can be seen in FIG. 4, preferably, threshing plates 430 and 432 are positioned such that their crop facing surface is flush with the fixed threshing bars 412. For example, as can be seen in FIG. 2, connection points 222A and 222B are placed above (in the figure) the bottom (in the figure) edges of the end and intermediary members. Preferably, the surface which comes into contact with the crop is flat and smooth to limit the damage to the crop. Additionally, the threshing plate fingers are pointing in the direction of crop flow to aid in self-cleaning and prevent plugging.

In an embodiment, the concave includes a frame and one or more arrays of elongated threshing elements or bars supported by the frame and one or more arrays of threshing plates supported by the frame. The components of the concave are preferably made of a suitable substantially rigid material, such as steel, aluminum, brass, plastic, carbon fiber, titanium, or other naturally occurring or manmade materials.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A threshing concave for an agricultural combine, comprising:
a curved frame comprising two curved end members extending between two side members;
a plurality of threshing bars, each threshing bar extending between the two curved end members; and
a plurality of threshing plates, each threshing plate extending between the two curved end members.

2. The threshing concave of claim 1, wherein each threshing plate has a flat surface with fingers extending therefrom.

3. The threshing concave of claim 2, wherein there are at least two lengths of fingers.

4. The threshing concave of claim 2, wherein the flat surface is positioned to come into contact with a crop when in use and the fingers extend in a direction of crop flow when in use.

5. The threshing concave of claim 1, further comprising an intermediary member positioned between the end members and the threshing bars and threshing plates extend between one end member and the intermediary member.

6. The threshing concave of claim 1, wherein the threshing bars and threshing plates extend to a same height within the concave.

7. The threshing concave of claim 1, wherein there is at least one array of threshing bars adjacent to each other and at least one array of threshing plates adjacent to each other.

8. The threshing concave of claim 1, wherein the concave is adapted to thresh multiple crops without adaptation.

9. The threshing concave of claim 1, wherein the threshing plates are removable and replaceable without disassembling the concave.

10. The threshing concave of claim 9, further comprising a plurality of threshing plate brackets adapted to provide a coupling point between the concave and the threshing plates.

11. An agricultural combine, comprising:
a rotor;
at least one threshing concave, wherein the threshing concave comprises:
a curved frame comprising two curved end members extending between two side members;
a plurality of threshing bars, each threshing bar extending between the two curved end members; and
a plurality of threshing plates, each threshing plate extending between the two curved end members.

12. The agricultural combine of claim 11, wherein each threshing plate has a flat surface with fingers extending therefrom.

13. The agricultural combine of claim 12, wherein there are at least two lengths of fingers.

14. The agricultural combine of claim 12, wherein the flat surface is positioned to come into contact with a crop when in use and the fingers extend in a direction of crop flow when in use.

15. The agricultural combine of claim 11, further comprising an intermediary member positioned between the end members and the threshing bars and threshing plates extend between one end member and the intermediary member.

16. The agricultural combine of claim 11, wherein the threshing bars and threshing plates extend to a same height within the concave.

17. The agricultural combine of claim 11, wherein there is at least one array of threshing bars adjacent to each other and at least one array of threshing plates adjacent to each other.

18. The agricultural combine of claim 11, wherein the concave is adapted to thresh multiple crops without adaptation.

19. The agricultural combine of claim 11, wherein the threshing plates are removable and replaceable without disassembling the concave.

20. The agricultural combine of claim 19, further comprising a plurality of threshing plate brackets adapted to provide a coupling point between the concave and the threshing plates.
